(19) United States
(12) Patent Application Publication
(10) Pub. No.: US 2018/0129486 A1
(43) Pub. Date: May 10, 2018

(54) SYSTEM AND METHOD FOR ESTIMATING PROGRAMMING CAPABILITY

(71) Applicant: INSTITUTE FOR INFORMATION INDUSTRY, TAIPEI (TW)

(72) Inventors: Shih-Chieh SU, Taichung City (TW); Chen-Wei CHUNG, Taoyuan City (TW); Chih-Chang YU, Taoyuan City (TW)

(21) Appl. No.: 15/350,116

(22) Filed: Nov. 14, 2016

(30) Foreign Application Priority Data
Nov. 9, 2016 (TW) 105136461

(51) Int. Cl. G06F 9/45; G06F 17/30

(52) U.S. Cl. CPC G06F 8/41; H04L 67/02; G06F 17/30424

(57) ABSTRACT

A system for estimating programming capability includes a database and a processing device, and the processing device is coupled to the database. The database is configured to store an online editing record message. The processing device is configured to execute steps as follows. A first condition is set according to a program. The online editing record message is compiled online to generate a compiling message. A determination is made whether the compiling message meets the first condition to generate a result message. A result of programming capability estimation is generated according to the result message.

### RELATED APPLICATIONS

This application claims priority to Taiwan Application Serial Number 105136461, filed Nov. 9, 2016, which is herein incorporated by reference.

### BACKGROUND

### Technical Field

The present invention relates to a technology of estimating programming capability. More particularly, the present invention relates to a system and a method for estimating programming capability.

### Description of Related Art

In order to estimate a learner's programming capability, syntactic and logic knowledge must be taken into consideration so that a program question is difficult to design. Moreover, it is also very difficult to determine the learner's level of program knowledge merely by an output of the program execution.

### SUMMARY

An aspect of the present disclosure is to provide a system for estimating programming capability. The system for estimating programming capability includes a database and a processing device. The processing device is coupled to the database. The database is configured to store an online editing record message of a program. The processing device is configured to execute steps as follows. A first condition is set according to the program. The online editing record message is compiled online to generate a compiling message. A determination is made whether the compiling message meets the first condition to generate a result message. A result of programming capability estimation is generated according to result message.

Another aspect of the present disclosure is to provide a method for estimating programming capability. The method for estimating programming capability includes steps as follows. An online editing record message of a program is compiled online to generate a compiling message. A first condition is set according to the program. A determination is made whether the compiling message meets the first condition to generate a result message. A result of programming capability estimation is generated according to result message.

In conclusion, through the above embodiments, the present disclosure can generate the result of programming capability estimation according to the online editing record message generated when the learner writes the program. Moreover, the present disclosure can also check the program knowledge that the learner is not familiar with through the first condition (corresponding to the program knowledge), the second condition (e.g., the key word), and therefore improve the program learning effect.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a system for estimating programming capability according to an embodiment of the present disclosure;

FIG. 2 is a flow chart of a method for estimating programming capability according to an embodiment of the present disclosure;

FIG. 3 is a schematic diagram of a result of programming capability estimation according to an embodiment of the present disclosure; and

FIG. 4 is a flow chart of a method for estimating programming capability according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

In this document, the term “coupled” may also be termed as “electrically coupled”, and the term “connected” may be termed as “electrically connected”. “coupled” and “connected” may also be used to indicate that two or more elements cooperate or interact with each other.

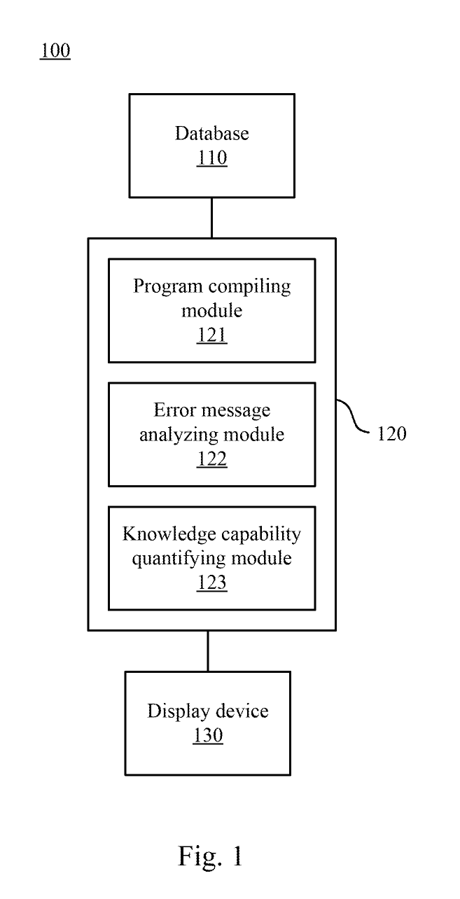

Reference is made to FIG. 1. FIG. 1 is a schematic diagram of a system 100 for estimating programming capability according to an embodiment of the present disclosure. The system 100 for estimating programming capability includes a database 110 and a processing device 120. The database 110 is coupled to the processing device 120.

In an embodiment, the processing device 120 can be configured to execute a program compiling module 121, an error message analyzing module 122 and a knowledge capability quantifying module 123. The program compiling module 121, the error message analyzing module 122 and the knowledge capability quantifying module 123 may be program code modules. However, the present disclosure is not limited thereto.

It should be noted that the program may be a program question that is used to test a learner's programming capability. A teacher may set at least one first condition in the program question through the processing device 120 to test the learner's capability of program knowledge. For example, the first condition may be set as program knowledge, such as data type, loop, operator, function and method. However, the present disclosure is not limited thereto.

Moreover, regard to program knowledge (e.g., loop) that covers a wide range, the teacher can further set at least one second condition (e.g., key words “if, for, while, etc”) in the first condition through the processing device 120 to check whether a program code written by the learner includes the key words of the second condition.

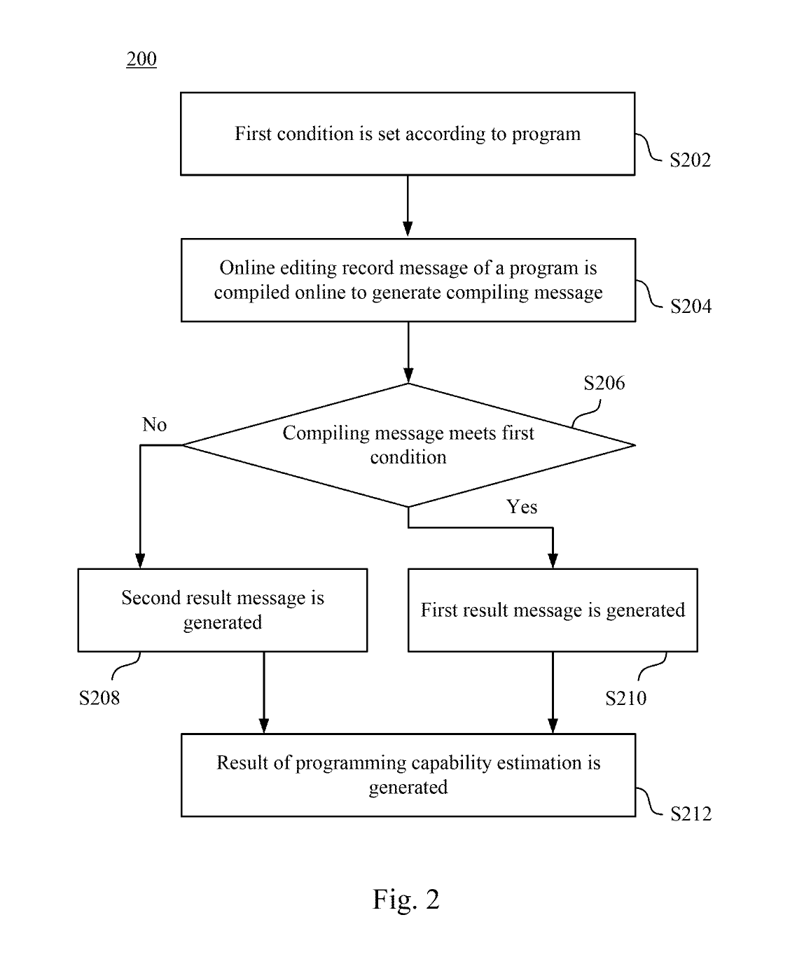

Reference is made to FIG. 2. FIG. 2 is a flow chart of a method 200 for estimating programming capability according to an embodiment of the present disclosure. The method 200 includes steps S202-S212, and the method 200 can be applied to the system 100 for estimating programming capability as shown in FIG. 1. However, those skilled in the art should understand that the mentioned steps in the present embodiment are in an adjustable execution sequence according to the actual demands except for the steps in a specially described sequence, and even the steps or parts of the steps can be executed simultaneously.

In an application situation, the teacher may set a series of questions (i.e., program questions) to test the learner's programming capability. Specifically, in step S202, the teacher sets the first condition in the program question through the processing device 120 to check whether the learner understand different program knowledge.

The learner may write the program question on an online programming interface, and the system 100 for estimating programming capability can record the learner's process of writing the program online in real time. The database 110 is configured to store an online editing record message of the program (i.e., the program question). In step S204, the processing device 120 executes the program compiling module 121 to compile the online editing record message online to generate a compiling message. In step S206, the processing device 120 executes the error message analyzing module 122 to determine whether the compiling message meets the first condition to generate a result message.

If the processing device 120 determines that the compiling message meets the first condition in step S206, then the processing device 120 generates a first result message to indicate that the learner understands the program knowledge corresponding to the first condition in step S210. Then, the processing device 120 executes the knowledge capability quantifying module 123 to generate the result of programming capability estimation (e.g., a score of program knowledge corresponding to the first condition is a high score) in step S212.

In contrast, if the processing device 120 determines that the compiling message does not meet the first condition in step S206, then the processing device 120 generates a second result message to indicate that the learner is not familiar with the program knowledge corresponding to the first condition in step S208. Then, the processing device 120 executes the knowledge capability quantifying module 123 to generate the result of programming capability estimation (e.g., a score of program knowledge corresponding to the first condition is a low score) in step S212.

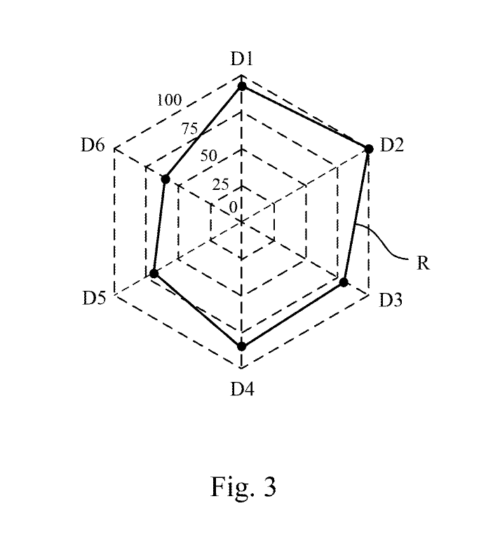

Reference is made to FIG. 3. FIG. 3 is a schematic diagram of a result of programming capability estimation according to an embodiment of the present disclosure. The teacher can set different first conditions in a series of program questions through the processing device 120 to test the learner's different program knowledge D1-D6. In an embodiment, the processing device 120 executes the knowledge capability quantifying module 123 to calculate the learner's knowledge capability value (e.g., a score within a range of 0-100, however, the present disclosure is not limited thereto) according to the result message so as to generate the result of programming capability estimation R. As shown in FIG. 3, the learner's result of programming capability estimation R represents the learner's levels for understanding the program knowledge D1-D6 through scores respectively. The processing device 120 can send the result of programming capability estimation R to a display device 130 for display.

As a result, the system for estimating programming capability 100 can analyze the learner's process of writing the program to reflect the learner's familiarity levels of different program knowledge.

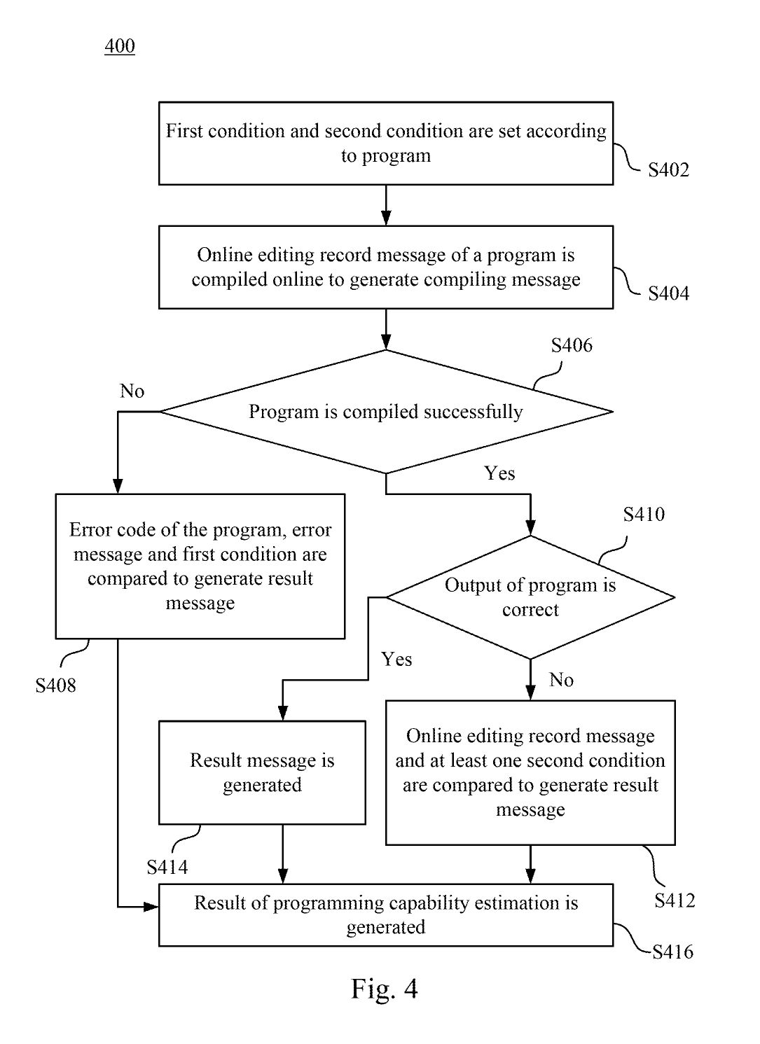

Reference is made to FIG. 4. FIG. 4 is a flow chart of a method 400 for estimating programming capability according to an embodiment of the present disclosure. The method 400 includes steps S402-S416, and the method 400 can be applied to the system 100 for estimating programming capability as shown in FIG. 1. However, those skilled in the art should understand that the mentioned steps in the present embodiment are in an adjustable execution sequence according to the actual demands except for the steps in a specially described sequence, and even the steps or parts of the steps can be executed simultaneously.

In a further embodiment, if the question (i.e., the program question) relates to the program knowledge that covers a wide range, the teacher can set the first condition (e.g., the program knowledge corresponding to loop) and the second condition (e.g., the key words if, for, while, etc.) according to the program through the processing device 120 in step S402. As aforementioned, the learner can write the program question through the online programming interface, and the system for estimating programming capability 100 can record the learner's process of writing the program online in real time. The database 110 is configured to store the online editing record message of the program (i.e., the program question). In step S404, the processing device 120 executes the program compiling module 121 to compile the online editing record message online to generate the compiling message.

When the processing device 120 determines that the compiling message includes an error message (i.e., the program has a compiling error) in step S406, the processing device 120 determines that the compiling message does not meet the first condition, and compares an error code of the program, the error message and the first condition to generate the result message so as to indicate that the learner is not familiar with the program knowledge corresponding to the first condition in step S408. Specifically, in step S408, the processing device 120 executes the error message analyzing module 122 to compare the error code that has the compiling error, the error message and the program knowledge corresponding to the first condition to generate the result message. Therefore, the result message can display the program knowledge that the learner is not familiar with and the program code that has the error in detail. Then, the processing device 120 executes the knowledge capability quantifying module 123 to generate the result of programming capability estimation (e.g., a score of program knowledge corresponding to the first condition is a low score) in step S416.

TABLE 1

| | | Corresponding |
|---|---|---|
| | Error message | program knowledge |
| 1 | Line 2, for i range (3): | <Loop> |
| | SyntaxError | |
| 2 | Line 2, for i in range (3) | <Operator> |
| | SyntaxError | |
| 3 | Line 1, print 3 + ‘hi’ | <Data type> |
| | TypeError: unsupported | |
| | operand type(s) for +: ‘int’ and | |
| | ‘str’ | |

For example, as shown in Table 1, when the compiling message include the error message 1, the processing device 120 executes the error message analyzing module 122 to compare the error message 1 with the program knowledge “loop” corresponding to the first condition in step S408. When the compiling message includes the error message 2, the processing device 120 executes the error message analyzing module 122 to compare the error message 2 with the program knowledge “operator” corresponding to the first condition in step S408. When the compiling message includes the error message 3, the processing device 120 executes the error message analyzing module 122 to compare the error message 3 with the program knowledge “data type” corresponding to the first condition in step S408.

As a result, when the program has the compiling error, the system for estimating programming capability 100 can effectively analyze specific program knowledge that the learner is not familiar with, and the specific program knowledge is reflected in the result message to further be displayed in the result of programming capability estimation.

On the other hand, when the processing device 120 determines that the compiling message includes a correct message (i.e., the program is compiled successfully) and output of the program is wrong in steps S406 and S410, the processing device 120 determines that the compiling message does not meet the first condition, and compare the online editing record message and the at least one second condition (e.g., the key words) set by the teacher to generate the result message so as to indicate that the learner is not familiar with the program knowledge corresponding to the first condition in step S412. Specifically, in step S412, the processing device 120 executes the error message analyzing module 122 to determine whether the online editing record message includes the at least one key word to generate the result message. For example, if the program question is used to test whether the learner uses for loop to solve the program question, then the processing device 120 executes the error message analyzing module 122 to determine whether the online editing record message includes a key word “for” to generate the result message in step S412. Then, the processing device 120 executes the knowledge capability quantifying module 123 to generate the result of programming capability estimation (e.g., a score of program knowledge corresponding to the first condition is a low score) in step S416.

As a result, when program written by the learner is compiled successfully and the output of the program is wrong, the processing device 120 can check whether the learner uses important program function in the program knowledge through the second condition (e.g., the key words). Therefore, the system for estimating programming capability 100 can check the important program function that the learner forgets to use, and effectively estimate the learner's programming capability to improve learning effect.

In contrast, when the processing device 120 determines that the compiling message includes the correct message (i.e., the program is compiled successful) and the output of the program is correct in steps S406 and S410, the processing device 120 determines that the compiling message meets the first condition, and generates the result message to indicates that the learner understand the program knowledge corresponding to the first condition in step S414. The processing device 120 executes the knowledge capability quantifying module 123 to generate the result of programming capability estimation (e.g., a score of program knowledge corresponding to the first condition is a high score) in step S416.

The database 110 can be stored in a storage device, such as a hard disk, any non-transitory computer readable storage medium, or a database accessible from network. Those of ordinary skill in the art can think of the appropriate implementation of the database 110 without departing from the spirit and scope of the present disclosure.

The above-mentioned program compiling module 121, the error message analyzing module 122 and the knowledge capability quantifying module 123 can be implemented as software, hardware and/or firmware. For example, if the execution speed and accuracy is a primary consideration, then each module and each unit can be mainly selected from hardware and/or software; if the design flexibility is a primary consideration, then each module and each unit can be mainly selected from software; and alternatively, each module and each unit can make use of software, hardware and firmware cooperatively. It should be known that, the above-mentioned examples are not classified as better or worse and they are not used to limit the invention. Those of skills in the art can flexibly select the specific implementation for each module and each unit, depending on the current demand. In an embodiment, the program compiling module 121, the error message analyzing module 122 and the knowledge capability quantifying module 123 can be integrated into a central processing unit (CPU). Alternatively, in another embodiment, the program compiling module 121, the error message analyzing module 122 and the knowledge capability quantifying module 123 may be computer programs that are stored in a storage device, and the computer programs includes a plurality of program instructions. The program instructions can be executed by the CPU so that the electricity consumption predicting system performs functions of the above modules.

In conclusion, through the above embodiments, the present disclosure can generate the result of programming capability estimation according to the online editing record message generated when the learner writes the program. Moreover, the present disclosure can also check the program knowledge that the learner is not familiar with through the first condition (corresponding to the program knowledge), the second condition (e.g., the key word), and therefore improve the program learning effect.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for estimating programming capability, comprising:
a database, configured to store an online editing record message of a program; and
a processing device, coupled to the database and configured to execute steps as follows:
setting a first condition according to the program;
compiling the online editing record message online to generate a compiling message;
determining whether the compiling message meets the first condition to generate a result message; and
generating a result of programming capability estimation according to the result message.

2. The system of claim 1, wherein the processing device is further configured to execute steps as follows:
when the compiling message comprises an error message, determining that the compiling message does not meet the first condition, and comparing an error code of the program, the error message and the first condition to generate the result message.

3. The system of claim 1, wherein the processing device is further configured to execute steps as follows:
setting at least one second condition according to the first condition; and
when the compiling message comprises a correct message and an output of the program is wrong, determining that the compiling message does not meet the first condition, and comparing the online editing record message and the at least one second condition to generate the result message.

4. The system of claim 3, wherein the at least one second condition comprises at least one key word, and the processing device is further configured to execute steps as follows:
when the compiling message does not meet the first condition, determining whether the online editing record message comprises the at least one key word to generate the result message.

5. The system of claim 1, further comprising:
a display device, coupled to the processing device and configured to display the result of programming capability estimation;
wherein the processing device is further configured to execute steps as follows:
calculating a knowledge capability value according to the result message to generate the result of programming capability estimation; and
sending the result of programming capability estimation to the display device for display.

6. A method for estimating programming capability, comprising:
compiling an online editing record message of a program online to generate a compiling message;
setting a first condition according to the program;
determining whether the compiling message meets the first condition to generate a result message; and
generating a result of programming capability estimation according to the result message.

7. The method of claim 6, further comprising:
when the compiling message comprises an error message, determining that the compiling message does not meet the first condition, and comparing an error code of the program, the error message and the first condition to generate the result message.

8. The method of claim 6, further comprising:
setting at least one second condition according to the first condition; and
when the compiling message comprises a correct message and an output of the program is wrong, determining that the compiling message does not meet the first condition, and comparing the online editing record message and the at least one second condition to generate the result message.

9. The method of claim 8, further comprising:
when the compiling message does not meet the first condition, determining whether the online editing record message comprises the at least one key word to generate the result message.

10. The method of claim 6, further comprising:
calculating a knowledge capability value according to the result message to generate the result of programming capability estimation; and
sending the result of programming capability estimation to a display device for display.
